(19) United States
(12) Patent Application Publication
(10) Pub. No.: US 2026/0193147 A1
(43) Pub. Date: Jul. 9, 2026

(54) FERTILIZER COMPRISING METAL SLAG AND COKE

(71) Applicant: SABIC AGRI-NUTRIENTS COMPANY, Riyadh (SA)

(72) Inventors: Mohamed AL-RABHI, Riyadh (SA); Aghaddin Khanlar MAMEDOV, Riyadh (SA)

(73) Assignee: SABIC AGRI-NUTRIENTS COMPANY, Riyadh (SA)

(21) Appl. No.: 19/129,408

(22) PCT Filed: Nov. 14, 2023
(86) PCT No.: PCT/IB2023/061494

§ 371 Date: May 13, 2025

Related U.S. Application Data
(60) Provisional application No. 63/425,076, filed on Nov. 14, 2022.

(51) Int. Cl. C05D 3/04

(52) U.S. Cl. CPC C05D 3/04

(57) ABSTRACT

Disclosed is a fertilizer containing a mixture containing coke and a metal slag. The coke may be from or contained in a mixed plastic waste slag and/or the metal slag may be from production of a metal. The coke, plastic waste slag, and/or metal slag may reacted with nitric acid. The fertilizer may also contain urea stabilized by a silicate and/or silica. Methods of making and using the fertilizer are also disclosed.

### CROSS-REFERENCE TO RELATED APPLICATIONS

This application claims priority to and the benefit of U.S. Provisional Application No. 63/425,076, filed Nov. 14, 2022, the contents of which is incorporated into the present application by reference in its entirety.

### BACKGROUND OF THE INVENTION

### I. Field of the Disclosure

This disclosure generally concerns fertilizer compositions using waste products as source material. In particular embodiments, the disclosure concerns fertilizers containing coke and/or slag products.

### II. Background

Soil nutrients are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Some approaches attempt to use some industrial waste products as fertilizers that provide a variety of plant nutrients such as phosphorous and calcium. These products also can possibly reduce the costs compared to purer sources of nutrients and reduce the environmental impact of industrial waste. However, industrial waste products often contain chemicals that have very little use as nutrients for plants or may be damaging to plants, do not provide a variety of plant nutrients in ratios needed for soils and plants, and/or do not provide plant nutrients in ratios of immediate release to long term release forms needed for soil and plants.

Application of a fertilizer does not always provide the full amount of the nutrients in the fertilizer to the plant within a short period of time. Some fertilizers contain nutrient containing compounds that are not readily available to the plant upon application. In these circumstances, some apply fertilizer well before the planting of plants, or some over fertilize closer to the planting of the plants to provide sufficient nutrients to the plant initially. However, this comes at the cost of time, may require multiple treatments to the soil before or after planting, and/or increases expenses.

Plants, such as crop plants, need nutrients at least over the entire growth and maturation period for the plant. However, many fertilizers when applied to a soil disperse, are degraded, or are taken up within a short period of time after application. To address this issue, fertilizers can be applied multiple times to the same plants or slow release fertilizers can be used. Some approaches to slow release fertilizers include polymer coating a fertilizer core. Though, many polymer coatings are expensive and/or will undesirably build up in the soil over time after repeated applications. Some approaches to slow release fertilizers include coating or mixing with insoluble metal oxides, such as MgO and CaO. However, these metal oxides do not provide much, if any, nutrients to the plant.

### SUMMARY OF THE INVENTION

A solution to at least some of the problems discussed above is disclosed herein, including generating a fertilizer product from waste products and generating a fertilizer product that has slow-release characteristics for its nutrients. Certain solutions dilute mixed plastic waste (MPW) slag with slag from a metal making process (metal slag), and use the processed mix as an ingredient for soil fertilizer that contains organic material from at least the MPW slag. In some instances, the MPW slag and/or metal slag are reacted with nitric acid to produce soluble nitrate nutrients and silicates and/or silica. In some instances, urea is also combined to form a silicate stabilized urea.

The value of MPW slag for fertilizers is disclosed herein. Mixtures of metal oxides and coke produced from decomposition of mixed plastic conversion is taught for agricultural application. Literature for mixed plastic conversion by-products suggest landfilling of slag of mixed plastics contaminated with coke. The fertilizers herein further provide a valuable alternative to landfilling mixed plastics decomposition slag.

In some embodiments, synthesis of at least part of the fertilizer occurs through reacting a slag, such as a metal slag and/or a MPW slag, with nitric acid to form at least calcium nitrate and/or magnesium nitrate, and/or a silicate and/or silica. In some embodiments, the silicate compounds and/or silica in the reaction product can be removed and dried. In some embodiments, the silicate compounds and/or silica in the reaction product can remain for further processing as outlined herein. Non-limiting example reactions that can occur include the following:

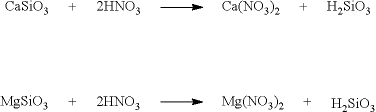

In some embodiments, synthesis of at least part of the fertilizer occurs through combining urea with silica and/or a silicate to form a stabilized urea for longer term release of nitrogen.

In some aspects, the slag and/or reaction product from the slag are combined with a source of carbon. In some aspects, the source of carbon comprises coke. The coke may be coke from or contained in slag from mixed plastic processing. The slag and/or reaction product may be combined with the source of carbon at any ratio, such as between approximately 5:1 to 1:5, such as 5:1, 4:1, 3:1, 2:1, 1:1, 1:2, 1:3, 1:4, or 1:5.

The final product may contain a mixture of the above composition chemicals, including, but not limited to any one or more of calcium nitrate, magnesium nitrate, silicate, hydrogen silicate, metasilicic acid, ammonium silicate, sulfuric acid, ammonium sulfate, urea, silica, calcium silicate, magnesium silicate, calcium oxide, magnesium oxide, iron oxide, manganese oxide, silicon oxide, aluminum oxide, barium oxide and/or barium compounds, zinc oxide and/or zinc compounds, and/or cadmium oxide and/or cadmium compounds. In some instances, the slag used to produce the fertilizer contains phosphorous compounds and phosphorous may exist in the final product as phosphoric acid and/or phosphate salts, such as calcium phosphate, magnesium phosphate, iron phosphate, aluminum phosphate, and/or manganese phosphate.

In some aspects, the reactions are performed in one or more than one container. In some aspects, the reactions are performed simultaneously or sequentially or a mixture of both.

Current slow-release fertilizer products often use physical intervention to slow the release of the fertilizer, such as by coating the fertilizer with a polymer insoluble material to slow the fertilizer's release. Current slow-release fertilizers may also employ enzymatic inhibitors, such as urease inhibitors or nitrification inhibitors, to slow the utilization of the fertilizer. Though the fertilizers described herein may also contain physical interventions and/or inhibitors, the fertilizers described herein do not always require such measures to produce a slow-release nutrient fertilizer composition, as the silicate compounds or silica can be used to physically entrap soluble nutrients to prevent immediate release when exposed to water.

Embodiments herein describe mixtures of nutrients, and the preparation of such mixtures, which play a role for generating a quick release and or soluble fertilizer or a slow release fertilizer in soil as a reservoir of nutrients for release over time. The fertilizer can include an immediate-release aspect of the fertilizer that can comprise or consist of added fertilizers, such as urea, soluble reactants or products of the reactions described herein, and any combination thereof, such as calcium nitrate, magnesium nitrate, iron nitrate, aluminum nitrate, and/or manganese nitrate. The slow-release aspect of the fertilizer can comprise or consist of one or more silicate compound, silica, and/or immediate-release fertilizers entrapped in the silicate compound and/or silica.

In some aspects, the fertilizer comprises or consists of coke and a metal slag. In some aspects, the fertilizer comprises or consists of coke, and one or more of calcium nitrate, magnesium nitrate, calcium silicate, magnesium silicate, nitric acid, metasilicic acid, urea, silicate, and silicate. In some aspects the fertilizer comprises or consists of a metal slag and coke comprised in mixed plastic waste slag. In some aspects the fertilizer comprises or consists of coke comprised in mixed plastic waste slag, a metal slag, and one or more of calcium nitrate, magnesium nitrate, urea, silica, and silicate. In some aspects the fertilizer further comprises or further consists of one or more of calcium oxide, magnesium oxide, iron oxide, manganese oxide, silicon oxide, barium oxide, zinc oxide, cadmium oxide, and/or aluminum oxide.

In certain aspects, the fertilizer is a homogenous mixture. The homogenous mixture, in some aspects, does not comprise a binder. The homogenous mixture, in some aspects, comprises a binder. The binder can comprise a slow-release agent. The slow-release agent can comprise ammonium silicate, silicate, hydrogen silicate, and/or metasilicic acid. In some aspects, the coke acts as a binder.

In some aspects, the fertilizer does not comprise a binding agent separate from a coke, silicate such as ammonium silicate, silica, hydrogen silicate, and/or metasilicic acid. In some aspects, the fertilizer does not comprise a binding agent separate from coke. The fertilizer can be a granular fertilizer.

In certain aspects, the fertilizer does not contain urea and/or a polymer. In certain aspects, the fertilizer further comprises urea and/or a polymer. In certain aspects, the fertilizer does not contain phosphorous and/or potassium.

A slag can be a byproduct from production of a metal, plastic, phosphate, etc. In some instances, a slag may contain silica and/or silicates and calcium, such as calcium oxide and/or calcium silicate, among other metal oxides. The other metal oxides can include, but are not limited to iron, magnesium, aluminum, and manganese. In some instances, slag contains phosphorous compounds, such as phosphoric acid. In certain aspects, the slag is slag from the production of metal such as steel, stainless steel, alloy steel, and/or carbon steel. In certain aspects, the slag is slag from production of plastics, such as mixed plastics and/or mix plastic waste. In some instances, slag contains coke. In some instances, a slag contains organic material, such as high molecular weight organic compounds. In some instances, slag from production of plastics contains organic material and/or coke. In some embodiments, pyrolysis of mixed plastics generates coke. The coke may comprise one or more minerals existing in the plastic. The elements that may exist in plastic decomposition, which includes coke, are Ca, Ba, Zn, and Cd. In certain aspects for cracking of mixed plastics and de-chlorination, CaO is used as an adsorbent for chlorine capture. The CaO, which may be from a mixed plastic conversion process, can be mixed with the coke fragments produced from plastic decomposition.

Certain aspects are directed to a method of making a fertilizer, including any fertilizer described herein. The method can include steps (a) and/or (b) and/or (c). In step (a), calcium silicate and/or magnesium silicate, such as those comprised in a metal slag, are contacted with coke, such as coke comprised in a plastic waste slag.

In optional step (b), that may be performed before, during, or after step (a), nitric acid is contacted with the calcium silicate and/or magnesium silicate, such as those comprised in a metal slag, and/or with the coke, such as coke comprised in a plastic waste slag to generate a product comprising calcium nitrate and/or magnesium nitrate, and a silicate, silica, and/or metasilicic acid. In some instances, step (b) does not react the calcium silicate and/or magnesium silicate with nitric acid and/or the coke with nitric acid together, but instead reacts nitric acid and calcium silicate and/or magnesium silicate separately from the reaction of the coke with nitric acid.

In optional step (c), that may be performed before, during, or after step (a) and/or (b), the products of step (a) and/or (b) and/or a silicate, silica, and/or metasilicic acid can be contacted with urea to generate a product comprising a stabilized urea that is at least partially entrapped to slow the release of urea when the fertilizer is contacted with water.

In certain aspects, the method of making the fertilizer further comprises drying the products and/or fertilizer mixture forms a solid fertilizer composition. Steps (a), (b), (c), and/or drying may occur at approximately 15° C. to 150° C., such as 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, and 150° C. In some aspects, steps (a), (b), and/or (c) may occur at 15 to 75° C. or any temperature or range therein.

In some aspects, the method includes combining a metal slag with a source of carbon to generate a mixture. The source of carbon may be a coke. The source of carbon may be mixed plastic waste slag. In some aspects, the metal slag is contacted with nitric acid. In some aspects, the carbon source is contacted with nitric acid. In some aspects, the mixture is contacted with nitric acid. In certain aspects, contacting the metal slag, the carbon source, or the mixture generates calcium nitrate and/or magnesium nitrate.

In some aspects, the fertilizer composition comprises or consists of any one or combination of: calcium nitrate, magnesium nitrate, iron nitrate, manganese nitrate, aluminum nitrate, silicate, silica, hydrogen silicate, metasilicic acid, ammonium silicate, magnesium silicate, sulfuric acid, ammonium sulfate, calcium silicate, urea, calcium oxide, magnesium oxide, iron oxide, manganese oxide, lead oxide, barium oxide, zinc oxide, cadmium oxide, and/or aluminum oxide. In some instances, the slag used to produce the fertilizer contains phosphorous compounds and phosphorous may exist in the fertilizer as phosphoric acid and/or phosphate salts, such as calcium phosphate, magnesium phosphate, iron phosphate, aluminum phosphate, and/or manganese phosphate.

Also disclosed are the following aspects 1 to 20 of the present invention.

Aspect 1 is a fertilizer composition comprising: coke; and metal slag comprising slag from the production of a metal.

Aspect 2 is the fertilizer composition of aspect 1, wherein the composition comprises a ratio of the coke to the metal slag between 1:1 and 1:5.

Aspect 3 is the fertilizer composition of any one of aspects 1 and 2, wherein the fertilizer comprises mixed plastic waste slag that comprises the coke.

Aspect 4 is the fertilizer composition of any one of aspects 1 to 3, wherein the metal slag comprises at least silicate and at least one metal oxide.

Aspect 5 is the fertilizer composition of aspect 4, wherein the silicate comprises calcium silicate.

Aspect 6 is the fertilizer composition of aspect 4 or 5, wherein the silicate comprises magnesium silicate.

Aspect 7 is the fertilizer composition of any one of aspects 4 to 6, wherein the metal oxide comprises calcium oxide, silicon oxide, iron oxide, magnesium oxide, aluminum oxide, and/or manganese oxide.

Aspect 8 is the fertilizer composition of any one of aspects 4-7, wherein the ratio of the silicate to the metal oxide is between 2:1 to 1:2.

Aspect 9 is the fertilizer composition of any one of aspects 1 to 8, further comprising an additional nutrient comprising nitrogen, phosphorus, and/or sulfur.

Aspect 10 is the fertilizer composition of aspect 9, wherein the additional nutrient comprises urea, calcium phosphate, ammonium phosphate, phosphoric acid, and/or calcium sulfate.

Aspect 11 is the fertilizer composition of any one of aspects 1 to 10, wherein the coke and/or metal slag is a reaction product of coke and/or metal slag, respectively, with nitric acid.

Aspect 12 is the fertilizer of any one of aspects 1 to 11, wherein the fertilizer composition comprises calcium nitrate, magnesium nitrate, a silicate, and/or SiO2.

Aspect 13 is the fertilizer of any one of aspects 1 to 12, wherein the fertilizer composition is dried.

Aspect 14 is a method of producing a fertilizer composition, the method comprising combining a coke source with a metal slag comprising slag from the production of a metal to generate a mixture.

Aspect 15 is the method of aspect 14, wherein the coke is comprised in a mixed plastic waste slag.

Aspect 16 is the method of any one of aspects 14 to 15, further comprising contacting the metal slag and/or coke source with nitric acid.

Aspect 17 is the method of aspect 16, wherein the contacting step occurs at 20 to 80° C. for 30 minutes to 6 hours.

Aspect 18 is the method of any one of aspects 16 to 17, wherein the contacting step generates calcium nitrate and/or magnesium nitrate.

Aspect 19 is the method of any one of aspects 14 to 18, further comprising drying the mixture.

Aspect 20 is the method of any one of aspects 14 to 19, wherein the method produces the fertilizer composition of any one of claims 1 to 13.

Aspect 21 is a method of fertilizing, the method comprising contacting a plant, a soil, water, or a combination thereof with the fertilizer compositions of any one of aspects 1 to 13.

The term “fertilizer” is defined as a material applied to soils or to plant tissues to supply one or more plant nutrients essential or beneficial to the growth of plants and/or stimulants or enhancers to increase or enhance plant growth.

The term “granule” can include a solid material. A granule can have a variety of different shapes, non-limiting examples of which include a spherical, a puck, an oval, a rod, an oblong, or a random shape.

The term “particle” can include a solid material less than a millimeter in its largest dimension.

The terms “particulate” or “powder” can include a plurality of particles.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the word “a” or “an” when used in conjunction with the term “comprising” may mean “one,” but it is also consistent with the meaning of “one or more,” “at least one,” and “one or more than one.”

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1: a schematic of a system and method for producing a fertilizer according to a non-limiting example of a system and method disclosed herein.

FIG. 2: a schematic of a system and method for producing a fertilizer according to another non-limiting example of a system and method disclosed herein.

### DETAILED DESCRIPTION OF THE INVENTION

Certain aspects of the present disclosure provide benefits over existing fertilizers, including by having slow-release characteristics for nutrients comprising the fertilizer. Certain aspects provided herein allow for the fertilizer to slowly release nutrients into the soil over a period of time, such as throughout a growing cycle for a plant. In some embodiments, the fertilizer comprises a silicate salt or a silicate salt reacted with nitric acid, urea, and/or a carbon source, such as a coke. The fertilizer may be one chemical composition and/or one homogenous mixture. Certain aspects relate to the production of carbon-containing fertilizer, which use, as a base material, metal making and mixed plastic conversion slags. Such slags, in reaction with nitric acid, may produce metal nitrate nutrients. The fertilizer may comprise urea, which increases nitrogen content of the fertilizer.

Certain aspects encompass fertilizers and their application and/or production, which contain organic materials. The organic materials may improve soil physico-chemical and biological properties. In certain aspects, the organic materials comprise biomass-derived charcoal, In certain aspects, biomass-derived charcoal has a bigger specific surface area than other charcoal. A bigger surface area may enhance adsorption of ammonium, nitrate, phosphoric acid, and some other water-soluble salt nutrient ions. In certain aspects, the fertilizer is used for plant nutrition, soil health improvement, or both.

Biomass charcoal containing fertilizers can be used as soil-amendment agents. Biomass charcoal based fertilizers can help carbon dioxide in the soil and can suppress soil microorganisms responsible for green house gas release; therefore, it has a positive impact to slow global warming trends. On this basis, our present invention has a purpose of development of organic material containing fertilizers.

Certain aspects herein use mixed plastic by-product coke as an organic matter source and as a binder for a mineral component of an organic-mineral fertilizer. Certain aspects utilize, such as by recycling, metal production and plastic conversion slags together to produce useful soil fertility and amendment products.

### I. Fertilizer

Certain embodiments herein concern a complex fertilizer comprising coke and slag. In some aspects, the coke provides carbon content, which may enrich the soil with organic matter, such as high weigh organic compounds. In some aspects, the slag comprises calcium silicate and/or magnesium silicate, either or both of which may be contacted with nitric acid. In some aspects, the contacted calcium silicate and/or magnesium silicate forms calcium nitrate and/or magnesium nitrate. Certain aspects involve synthesis of the nutrient complex using waste product and/or by-product sources of ingredients of the fertilizer. In some aspects, ingredients include by-products of a metal making process. In certain aspects, ingredients include by-products of a process for making plastic and/or plastic precursors. In some aspects, the fertilizer is a mixture that is a homogeneous mixture.

The fertilizer, which may be a fertilizer granule, can contain a mixture containing carbon (C), calcium (Ca), silicon (Si), iron (Fe), magnesium (Mg), aluminum (Al), sulfur(S), phosphorus (P), nitrogen (N), and/or manganese (Mn), any of which may be in a salt or molecule. The ratio of elements present in the fertilizer may be tailored to specific applications.

In some embodiments 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 99.5 wt. % of the mixture is coke. The coke ingredient of the mixture provide carbon to the soil and/or be used as a binder to form pellets containing other added nutrients. In some aspects, the added nutrients to the mixture can be any chemical compound comprising nitrogen, phosphorus, potassium, and/or sulfur.

In some embodiments 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 99.5 wt. % of the mixture is slag or a slag product. In some aspects, a slag product is a slag that has been reacted with an acid, such as nitric acid. In some aspects, the slag or slag product comprises calcium silicate, magnesium silicate, calcium nitrate, magnesium nitrate, and/or aluminum oxide. In some aspects, the slag comprises a mixture of compounds shown in Table 1.

TABLE 1
Examples of iron and steel slag compositions

| | Percentage of compound in the slag | | | | | |
|---|---|---|---|---|---|---|
| | Blast | | | | | |
| | furnace | Converter | Oxidizing | Reducing | | Ordinary |
| Compound | slag | slag | slag | slag | Andesite | cement |
| CaO | 41.7 | 45.8 | 22.8 | 55.1 | 5.8 | 64.2 |
| SiO₂ | 33.8 | 11.0 | 12.1 | 18.8 | 59.6 | 22.0 |
| T—Fe | 0.4 | 17.4 | 29.5 | 0.3 | 3.1 | 3.0 |
| MgO | 7.4 | 6.5 | 4.8 | 7.3 | 2.8 | 1.5 |
| Al₂O₃ | 13.4 | 1.9 | 6.8 | 16.5 | 17.3 | 5.5 |
| S | 0.8 | 0.06 | 0.2 | 0.4 | — | 2.0 |
| P₂O₅ | <0.1 | 1.7 | 0.3 | 0.1 | — | — |
| MnO | 0.3 | 5.3 | 7.9 | 1.0 | 0.2 | — |

In some embodiments 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 99.5 wt. % of the mixture is coke, and the remaining 99.5, 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, or 0.5 wt % of the mixture is slag or a slag product.

At least a portion of carbon can be present as coke. In some aspects, at least 90 wt. %, or at least 95 wt. %, or 90 wt. % to 100 wt. %, or at least any one of, at most any one of, equal to any one of, or between any two of 90, 91, 92, 93, 94, 95, 96, 97, 98, 99, 99.5, and 100 wt. % of the carbon in the mixture can be present as coke, based on the total weight of carbon in the mixture. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the mixture is carbon or coke.

At least a portion of Ca can be present as calcium silicate, calcium nitrate, and/or calcium oxide. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Ca in the mixture can be present as calcium silicate. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Ca in the mixture can be present as calcium nitrate. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Ca in the mixture can be present as calcium oxide.

At least a portion of Mg can be present as magnesium silicate, magnesium nitrate, and/or magnesium oxide. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Mg in the mixture can be present as magnesium silicate. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Mg in the mixture can be present as magnesium nitrate. In some embodiments, at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % of the Mg in the mixture can be present as magnesium oxide.

In some aspects, the mixture can comprise a metal oxide, including calcium oxide, silicon oxide, iron oxide, magnesium oxide, aluminum oxide, manganese oxide, cadmium oxide, barium oxide, zinc oxide, and/or lead oxide, in an amount at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % based on the total weight of the mixture and/or the fertilizer granule; ii) urea in an amount providing at least any one of, at most any one of, equal to any one of, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, and 100 wt. % based on the total weight of the mixture and/or the fertilizer granule; and/or iii) silica in an amount providing at least any one of, at most any one of, equal to any one of, or between any two of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, and 99 wt. % based on the total weight of the mixture and/or the fertilizer granule.

Any salt or molecule described herein can be present as and/or sourced as a water soluble compound or a water insoluble compound. In some instances, the Ca, Mg, N, P, and/or S can be present as a salt, such as calcium nitrate and/or magnesium nitrate. The salt can be in a non-hydrate and/or one or more hydrate form.

Moisture content of the dried fertilizer can be less than 1 wt. %, such as 0.1 wt. % to 0.9 wt. %, or any one of or between any two of 0.1, 0.2, 0.3, 0.4, 0.5, 0.6, 0.7, 0.8, 0.9, or 1 wt. %, or any range thereof, based on the weight of the fertilizer granule. As a non-limiting example, the moisture content can be measured by drying the sample at 50° C., for 25 min and measuring the amount of mass lost by the fertilizer after being dried.

The fertilizer can be of any suitable shape. Non-limiting shapes include spherical, cuboidal, cylindrical, puck shape, oval, and oblong shapes. In some aspects, the fertilizer granule can be of cylindrical shape with a circular, elliptical, ovular, triangular, square, rectangular, pentagonal, or hexagonal cross section, although cylindrical shaped core having a cross-section of other shapes can also be made. In some aspects, the fertilizer granule at its widest dimension can be 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm. In some particular aspects, the fertilizer granule can have a substantially spherical shape with an average diameter 0.5 mm to 6 mm, or 0.5 mm to 5 mm, preferably 1 mm to 4 mm, or at least any one of, at most any one of, equal to any one of, or between any two of 0.5 mm, 1 mm, 1.5 mm, 2 mm, 2.5 mm, 3 mm, 3.5 mm, 4 mm, 4.5 mm, 5 mm, 5.5 mm, and 6 mm.

The fertilizer can be water and/or soil dispersible. In some aspects, a fertilizer granule having a size of 2 mm to 4 mm prior to adding to water, can disintegrate into particles having sizes less than 1 mm, less than 0.9 mm, less than 0.8 mm, less than 0.7 mm, less than 0.6 mm, less than 0.5 mm, less than 0.4 mm, or less than 0.3 mm, within 1 minute of adding the granule to water at a pH 7, under stirring at a rate 90 rpm to 110 rpm, at an ambient temperature.

The mixture can have a compositional make-up that is substantially homogeneous. In some instances, a compositional make-up for a 1 mm×1 mm×1 mm cube at any position of the mixture can be similar (within ±20%, or ±10%, or ±5%, or ±3%, ±2%, or ±1%, or ±0.5%) to that of a 1 mm×1 mm×1 mm cube at any other position of the mixture.

In some aspects, the fertilizer granule can contain an homogeneous mixture. The homogeneous mixture can have compositions as described above. In some instances, the homogenous mixture can have an optional coating on the outer surface of the homogenous mixture. In some instances, the fertilizer comprises particles of the slow-release agent(s) and/or of immediate-release agent(s).

In some aspects, additional fertilizer substances can be included or excluded in the fertilizer. If included, additional fertilizers can be chosen based on the particular needs of certain types of soil, climate, or other growing conditions to maximize the efficacy of the fertilizer in enhancing plant growth and crop yield. Additional additives may also be included or excluded in the fertilizer. Non-limiting examples of additives that can be included or excluded from the fertilizer of the present invention include additional nitrogen nutrients, additional phosphorus nutrients, additional potassium nutrients, additional micronutrients, and/or additional secondary nutrients. The micronutrient can be copper, iron, chloride, manganese, molybdenum, or nickel, or any combinations thereof. The nitrogen nutrient can be urea, ammonium nitrate, ammonium sulfate, diammonium phosphate, monoammonium phosphate, urea-formaldehyde, ammonium chloride, and potassium nitrate. In some aspects, the additional secondary nutrients may include lime and/or superphosphate. In some instances, the additional fertilizer substances and/or the additional additives are contained in the optional coating of the fertilizer.

In some instances, the inhibitors include nitrification inhibitors and/or urease inhibitors. Suitable nitrification inhibitors include, but are not limited to, 3,4-dimethylpyrazole phosphate (DMPP), dicyandiamide (DCD), thiourea (TU), 2-chloro-6-(trichloromethyl)-pyridine (Nitrapyrin), 5-ethoxy-3-trichloromethyl-1,2,4-thiadiazol, which is sold under the tradename Terrazole®, by OHP Inc., USA, 2-amino 4-chloro 6-methyl pyrimidine (AM), 2-mercaptobenzothiazole (MBT), or 2-sulfanilamidothiazole (ST), and any combination thereof. In one aspect, a nitrification inhibitor can comprise DMPP, DCD, TU, nitrapyrin, 5-ethoxy-3-trichloromethyl-1,2,4-thiadiazol, AM, MBT, or ST, or a combination thereof. In some embodiments, a fertilizer composition can comprise NBTPT, DMPP, TU, DCD, PPDA, nitrapyrin, 5-ethoxy-3-trichloromethyl-1,2,4-thiadiazol, AM, MBT, ST, or a combination thereof.

In some instances, a binder includes a phosphate, a polyphosphate, a biodegradable polymer, or a wax, or a combination thereof. Suitable waxes include, but are not limited to, vegetable waxes, high melt waxes, ethylene bis(stearamide) wax, paraffin waxes, polyethylene based waxes, and olefin waxes. Suitable phosphates include, but are not limited to, diammonium phosphate, and monoammonium phosphate. Suitable polyphosphates include, but are not limited to, ammonium polyphosphate. Suitable biodegradable polymers include, but are not limited to, polyacrylamide, polyacrylic acid, polyacrylonitrile, biodegradable polylactic acid and other biodegradable polymeric material such as polylactic acid, poly(3-hydroxypropionic acid), polyvinyl alcohol, poly e-caprolactone, poly L-lactide, poly butylene succinate, and biodegradable starch based polymers. The binder can include plaster of Paris, flour, starch, gluten, kaolin, bentonite, colloidal silica, or combinations thereof. Suitable flours include, but are not limited to, rice flour, wheat flour, and bleached wheat flour. Suitable starches include, but are not limited to, dextrin modified starches.

In some instances, the pH buffers include MgO, KH₂PO₄, NaHCO₃, chalk powder, aluminum, magnesium hydroxide, aluminum hydroxide/magnesium hydroxide co-precipitate, aluminum hydroxide/sodium bicarbonate co-precipitate, calcium acetate, calcium bicarbonate, calcium borate, calcium carbonate, calcium bicarbonate, calcium citrate, calcium gluconate, calcium hydroxide, dibasic sodium phosphate, dipotassium hydrogen phosphate, dipotassium phosphate, disodium hydrogen phosphate, magnesium acetate, magnesium borate, magnesium bicarbonate, magnesium carbonate, magnesium hydroxide, magnesium lactate, magnesium oxide, magnesium phosphate, magnesium silicate, magnesium succinate, magnesium tartrate, potassium acetate, potassium carbonate, potassium bicarbonate, potassium borate, potassium citrate, potassium metaphosphate, potassium phthalate, potassium phosphate, potassium polyphosphate, potassium pyrophosphate, potassium succinate, potassium tartrate, sodium acetate, sodium bicarbonate, sodium borate, sodium carbonate, sodium citrate, sodium gluconate, sodium hydrogen phosphate, sodium hydroxide, sodium lactate, sodium phthalate, sodium phosphate, sodium polyphosphate, sodium pyrophosphate, sodium tartrate, sodium tripolyphosphate, synthetic hydrotalcite, tetrapotassium pyrophosphate, tetrasodium pyrophosphate, tripotassium phosphate, trisodium phosphate, and trometamol, and combinations thereof.

The fertilizer escribed herein can be comprised in a composition useful for application to soil. In some aspects, in addition to the fertilizer described herein, the composition may include other fertilizer compounds, micronutrients, primary nutrients, urea, additional nitrogen nutrients, insecticides, herbicides, or fungicides, or combinations thereof. The fertilizer described herein can also be included in a blended composition comprising other fertilizers. The other fertilizer can be urea, monoammonium phosphate (MAP), diammonium phosphate (DAP), muriate of potash (MOP), monopotassium phosphate (MKP), triple super phosphate (TSP), rock phosphate, single super phosphate (SSP), ammonium sulfate, and the like.

A fertilizer formed into a granule can have desirable physical properties such as desired levels of abrasion resistance, granule strength, pelletizability, hygroscopicity, granule shape, and size distribution. In some aspects, The fertilizer granule can have a crush strength above 1.5 kgf, such as above 1.8 kgf, such as 2 kgf to 6 kgf, or at least any one of, equal to any one of, or between any two of 2, 2.5, 3, 3.5, 4, 4.5, 5, 5.5, and 6 kgf. Bulk density of the fertilizer granules can be 1 g/cc to 1.2 g/cc, or at least any one of, at most any one of, equal to any one of, or between any two of 1, 1.02, 1.04, 1.06, 1.08, 1.1, 1.12, 1.14, 1.16, 1.18, and 1.2 g/cc. In some aspects, 10 mg or more, such as 10 mg to 40 mg, or at least any one of, at most any one of, equal to any one of, or between any two of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 mg of the fertilizer granule can dissolve in 1 ml of water at a pH 7, under stirring at a rate 90 to 110 rpm, and at an ambient temperature, within 5 minutes of adding 100 mg of the fertilizer granules to the water. In some aspects, the fertilizer granule is capable of losing less than 0.13 wt. %, such as 0.02% to 0.12 wt. %, or at most any one of, equal to any one of, or between any two of 0.02, 0.03, 0.04, 0.05, 0.06, 0.07, 0.08, 0.09, 0.1, 0.11, and 0.12 wt. % in an attrition loss test. Attrition loss can be measured using the following attrition loss test.

Attrition loss test: A plurality of sieved fertilizer granules with individual size 2 to 4 mm, and total volume 100 cm³ is weighed (W1) and is placed into the test drum along with the 50 stainless steel balls having a total weight of 100 μm. The drum is closed and rotated for 10 min at 30 rpm. Then, the steel balls are separated from the sample and the material is screened over 2 mm sieve using a sieve shaker. The total weight of the granules over 2 mm are then re-weighed (W2). Results are calculated in terms of % weight loss using the formula:

$$Weight loss due to attraction ( wt . \% ) = \frac{weight of sample remained on 2 mm sieve ( ( W 2 ) )}{initial weight of the sample ( W 1 )} \times 100$$

### II. Method of Making a Fertilizer

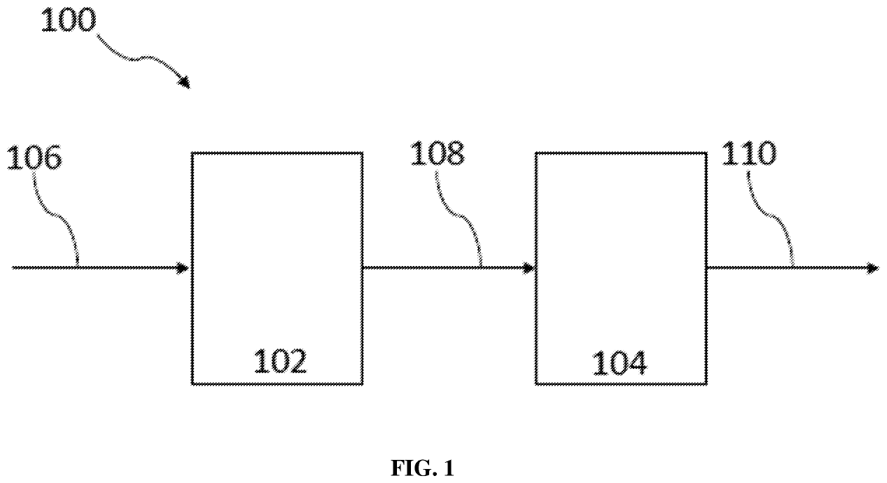

Referring to FIG. 1, a schematic of a system and method for making a fertilizer according to one example of the present invention is described. The system 100 can include a granulator 102 and a dryer 104. A feed mixture 106 can be granulated in the granulator 102 in the presence or absence of water to form a wet granulated mixture 108. The water, if present, can be provided with the feed mixture 106, and/or can be added separately to the granulator 102. The wet granulated mixture 108 can be dried in the dryer 104 to obtain dry granulated mixture 110 containing the fertilizer.

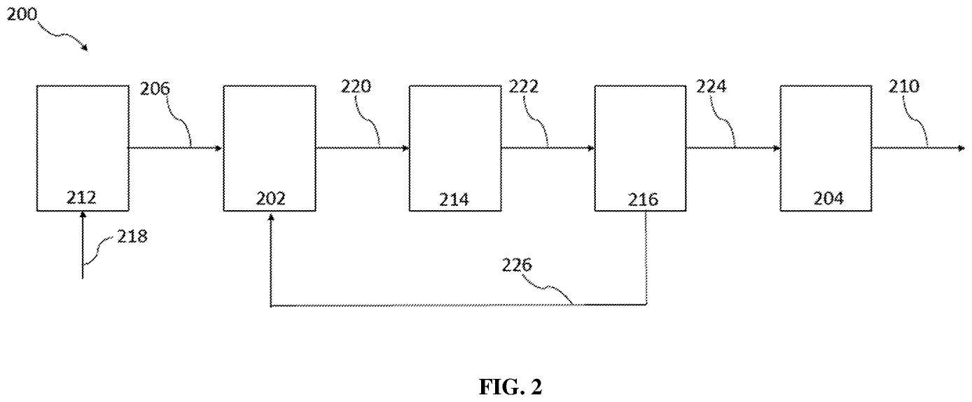

Referring to FIG. 2, a schematic of a system and method for making a fertilizer according to another example of the present invention is described. The system 200 can include a mixer/reactor 212, though the mixer and the reactor can be two, three, four, or more components, such as two reactors and a mixer or a reactor and a mixer. The system 200 can include a granulator 202, a spheronizer 214, one or more size screens 216, and a dryer 204, or any combination thereof. The feed mixture ingredients 218, separately and/or at any possible combination can be added to the mixer/reactor 212. In the mixer/reactor 212, the feed ingredients can be reacted and/or mixed to form the feed mixture 206. Feed mixture 206 can be granulated in the granulator 202 in presence or absence of additional water to form a wet granulated mixture 220. Granules of the wet granulated mixture 220 can be spheronized in the spheronizer 214 to form a wet granulated mixture 222 containing substantially spherical granules. The wet granulated mixture 222 can be passed through one or more size screens 216 to separate granules having a size smaller or bigger than a desired size from the wet granulated mixture 222 and obtain a wet granulated mixture 224 containing granules of desired size. At least a portion of the granules separated 226 from the granulation mixture 224 containing granules of desired size can be recycled to the granulator 202. The wet granulated mixture 224 containing granules of desired size can be dried in the dryer 204 to obtain dry granulated mixture 210 containing the fertilizer granule. In some aspects, the mixer/reactor 212 can contain a ribbon mixer.

The feed mixture ingredients 218 can include i) a coke source, e.g., plastic waste slag such as mix plastics waste slag, ii) a calcium silicate and/or magnesium silicate source, e.g., slag from metal production, iii) a N source, e.g., nitric acid and/or urea, and/or iv) a silica and/or silicate source. In some instances, a mixture ingredient provides additional nutrients and/or micronutrients, such as P, K, Fe, and/or S. In certain aspects, one or more ingredients can be added as a water solution. In some instances, the mixture ingredients are provided as a powder. In some instances, one or more ingredients can be added as a gas. In some instances, the NH₃ is provided at a pressure above 1 bar, such as at, or between, or of any range of 1.2, 1.3, 1.4, 1.5, 2, 2.5, 3, 3.5, 4, 4.5, 5, 5.5., 6, 6.5, 7, 7.5, 8, 9, 10, 15, 20, 25, 30, 35, and 40 bar. In some instances, a portion of the mixture ingredients are provided as a powder.

The feed mixture 106, 206 can contain nitric acid, metal slag, coke such as coke from or comprised within a mixed plastic waste slag, calcium nitrate, magnesium nitrate, urea, silicate, silica, urea entrapped by silicate and/or silica, etc.

Water can be added to the feed mixture in the mixer/reactor 212 and/or in the granulator 102, 202. In certain aspects, 5 μm to 20 μm, or at least any one of, at most any one of, equal to any one of, or between any two 5, 6, 7, 8, 9, 10, 11, 12, 13, 14, 15, 16, 17, 18, 19, and 20 μm of water in total (e.g., added with one or more feed mixture ingredients and/or separately) can be added to the feed mixture, per 100 μm of feed mixture.

In some aspects, the granulator 102, 202 can be a drum granulator, pugmill granulator, pan granulator, solid mixer, abrasion drum, extruder, high-shear mixer granulator, roller granulator, mycromix, or a round bottom flask. In the granulator 102, 202 the feed mixture 106, 206 can be granulated by agglomeration, spray granulation, compaction, slurry granulation and/or high-shear mixer granulation. In some particular aspect, the feed mixture 106, 206 can be granulated in the granulator 102, 202 by compaction. In some aspects, the granulator 102, 202 can contain at least two rollers and compaction granulation can include compressing the feed mixture using the at least two rollers. In some aspects, the two rollers can be moved in counter current direction during compaction. In some aspects, the feed mixture can be compressed into shaped pellets, such as cylindrical pellets, by the at least two rollers. In some aspects, a surface of one roller can have desired holes to compress the feed mixture into the holes, and the surface of the other roller can push the feed mixture into the holes. Pressure during granulation, e.g. compaction granulation can be 1 bar to 40 bar, or at least any one of, at most any one of, equal to any one of, or between any two 1, 2, 3, 4, 5, 10, 15, 20, 25, 30, 35, and 40 bar. In certain aspects, the feed mixture can be granulated in the granulator 102, 202 at ambient temperature to 50° C., or at least any one of, at most any one of, equal to any one of, or between any two of −20, −15, −10, 0, 5, 10, 15, 20, 25, 30, 35, 40, 45 and 50° C.

In some aspects, reacting of the feed mixture ingredients, mixing, and granulating the feed mixture can be performed in different containers, e.g., the mixer/reactor 212 and the granulator 202 can be different containers. In some aspects, reacting of the feed mixture ingredients, mixing, and granulating the feed mixture can be performed in the same container, e.g., the mixer/reactor 212 and the granulator 202 can be the same container (not shown). In some aspects, the mixer/reactor 212 and the granulator 202 can be more than two containers. As non-limiting examples, in some instances, the nitrates (e.g., calcium nitrate and/or magnesium nitrate) and urea entrapped by silica and/or silicates are formed in two different containers. In some instances, the nitrates (e.g., calcium nitrate and/or magnesium nitrate) and urea entrapped by silica and/or silicates are formed in one container. In some instances, the coke and metal slag mixture and the urea entrapped by silica and/or silicates are formed in two different containers.

In some aspects, the products described herein are formed at a temperature of at least, at most, equal to, or between any two of 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, or 150° C., such as between 4° and 150° C. or between 10° and 150° C. or between 75 and 150° C. or between 55 to 75° C.

In some instances, the fertilizer can be extruded before drying. The extruder can extrude the fertilizer at pressures at least, at most, equal to, or between any two of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40 bar. The extruder can extrude the fertilizer at temperatures at least, at most, equal to, or between any two of −20, −15, −10, 0, 5, 10, 15, 20, 25, 30, 35, 40, 45 and 50° C. The extrudate can be sliced or divided before drying, such as by a die.

In certain aspect, the desired size of a final fertilizer product, such as a granule, can be 0.5 to 5 mm, or 1 to 4 mm, and having a size lower than 0.5 mm or 1 mm, and/or having a size bigger than 4 mm or 5 mm can be separated from the wet granulated mixture 222 in the one or more size screens 216. In certain aspects, the wet granulated mixture can be rounded and/or spheronized in a spheronizer. In some instances, the wet granulated mixture is contacted with a spheronizer for at least any one of, at most any one of, equal to any one of, or between any two of 5, 10, 15, 20, 25, 30, 35, 40, 50, or 60 seconds. The spheronizer in some instances has a rotating or rotatable disk capable of rotating at least any one of, at most any one of, equal to any one of, or between any two of 200, 500, 1000, 1500, 2000, 2500, 3000, 3500, 4000, 4500, 5000 rpm. In certain aspects, the wet granulated mixture can be dried in the dryer 104, 204 at a temperature 40° C. to 85° C., or at least any one of, at most any one of, equal to any one of, or between any two of 40, 45, 50, 55, 60, 65, 70, 75, 80 and 85° C. In some aspects, the dryer 104, 204 can be a fluid bed dryer, drum dryer, or flash dryer. In some aspects, the wet granulated mixture can be dried in the dryer 104, 204 with an hot air flow having a flow rate of at least any one of, at most any one of, equal to any one of, or between any two of 100, 150, 200, 250, 300, 350, 400, 450, and 500 m³/hr and/or a rotation of at least any one of, at most any one of, equal to any one of, or between any two of 5, 10, 15, 20, 25, 30, 35, 40, 45, and 50 rpm.

In certain aspects, preparation of the fertilizer comprises mixing slag, such as from a metal making plant, with coke, such as coke fragments produced in the process of thermal cracking mixed plastics (which may contain about 4-5% of metal oxides, such as CaO, CdO, BaO, ZnO, and PbO). The ratio during mixing can be varied in a wide range, including metal slag to coke (such as mixed plastic waste (MPW) slag) of 5:1 to 1:5. The mixture of metal slag to coke (such as MPW slag) can be added to a solution of urea and/or nitric acid with weight ratios of urea to slags of 4:1 and nitric acid to slags of 1:1. In some aspects, the material is dried at approximately 80° C. for approximately 4 hours.

In certain aspects, preparation of the fertilizer comprises the following reactions:

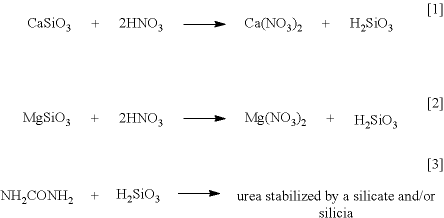

The reaction [3] may comprise incorporation of urea to the pores of a silicate, silica, hydrated silica, and/or metasilicic acid through covalently bonding urea within a silicate, silica, hydrated silica, and/or metasilicic acid, which may enhance its stability and/or provide a prolonged release of urea.

In some aspects, the final product comprises Ca(NO₃)₂, Mg(NO₃)₂, and urea stabilized by a silicate and/or silica.

Certain aspects concern methods for preparing a carbon-containing coating material for the production of fertilizer. The fertilizer may comprise a combination of metal production slag and waste plastics conversion slag. In some aspects, the fertilizer also comprises nitrogen-containing ingredients. In some aspects, the metal production slag is a Ca, Mg, and/or Si containing mineral material. In some aspects, coke, which may be slag from a mixed plastic conversion, contains CaO, CdO, BaO, and/or ZnO, which may be in an amount of less than 1%. In some aspects, the coke, which may be a mixed plastic conversion slag, is mixed with the metal oxides. In some aspects, the fertilizer comprises a coating material. The coating material may comprise nitrogen. In some aspects, the source of nitrogen is urea and/or nitric acid. In some aspects, the weight ratio of urea to the one or more slags is 3:1. In some aspects, the weight ratio of nitric acid to the one or more slags is 1:1.

### III. Methods of Using the Fertilizer

The fertilizer, including fertilizer granules, compositions containing the fertilizer, and fertilizer blends containing the fertilizer of the present disclosure can be used in methods of increasing the amount of one or more plant nutrients in soil and of enhancing plant growth. Such methods can include applying to the soil an effective amount of a composition and/or blend containing the fertilizer of the present invention. The method may include increasing the growth and yield of crops, trees, ornamentals, etc., such as, for example, palm, coconut, rice, wheat, corn, barley, oats, and/or soybeans. The method can include applying the fertilizer blend of the present invention to at least one of a soil, an organism, a liquid carrier, a liquid solvent, etc. The composition(s) and/or fertilizer blends(s) containing the fertilizer can be applied to plants and/or soil as a top dressing fertilizer, basal fertilizer, and/or through any suitable method of application.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes.

The effectiveness of compositions comprising the fertilizer of the present invention can be ascertained by measuring the amount of phosphorus and optionally other nutrients in the soil at various times after applying the fertilizer composition to the soil. It is understood that different soils have different characteristics, which can affect the stability of the nutrients in the soil. The effectiveness of a fertilizer composition can also be directly compared to other fertilizer compositions by doing a side-by-side comparison in the same soil under the same conditions.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### I. Example 1—Producing a Fertilizer

42 g of 68% nitric acid solution can be diluted with water to 150 mL. 50 g of calcium silicate can be added to the solution. The mixture can be stirred at 25° C. for two hours. 8 g of urea can be added to the produced solution. The mixture can be gradually dried at 60° C. ramping to 80° C. over 8 hours. The produced material can be ground to 20-80 mesh size. The content of nitrogen in the produced material can be 19%.

### II. Example 2—Producing a Fertilizer

Slag from a steel making plant can be mixed with coke fragments produced in a process of thermal cracking of mixed plastics. The coke fragments may contain about 4-5% of metal oxides, such as CaO, CdO, BaO, ZnO and PbO. The ratio during mixing can be varied in a wide range, such as steel slag to MPW slag at 5:1.

The mixture of steel slag/MPW slag can be added to a solution of urea and nitric acid with weight ratios of urea to slags of 4:1 and nitric acid to slags of 1:1.

The material can be dried at 80° C. for 4 hours.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

1. A fertilizer composition comprising:
mixed plastic waste slag that comprises coke; and
metal slag comprising slag from the production of a metal,
wherein the coke and/or metal slag is a reaction product of coke and/or metal slag, respectively, with nitric acid.

2. The fertilizer composition of claim 1, wherein the composition comprises a ratio of the coke to the metal slag between 1:1 and 1:5.

3. The fertilizer composition of claim 1, further comprising high molecular weight organic compounds and one or more of: CaO; CdO; BaO; ZnO; and PbO.

4. The fertilizer composition of claim 1, wherein the metal slag comprises at least silicate and at least one metal oxide.

5. The fertilizer composition of claim 4, wherein the silicate comprises calcium silicate.

6. The fertilizer composition of claim 4, wherein the silicate comprises magnesium silicate.

7. The fertilizer composition of claim 4, wherein the metal oxide comprises calcium oxide, silicon oxide, iron oxide, magnesium oxide, aluminum oxide, and/or manganese oxide.

8. The fertilizer composition of claim 4, wherein the ratio of the silicate to the metal oxide is between 2:1 to 1:2.

9. The fertilizer composition of claim 1, further comprising an additional nutrient comprising nitrogen, phosphorus, and/or sulfur.

10. The fertilizer composition of claim 9, wherein the additional nutrient comprises urea, calcium phosphate, ammonium phosphate, phosphoric acid, and/or calcium sulfate.

11. The fertilizer composition of claim 1, further comprising high molecular weight organic compounds, CaO, CdO, BaO, ZnO, and PbO.

12. The fertilizer of claim 1, wherein the fertilizer composition comprises calcium nitrate, magnesium nitrate, a silicate, and/or SiO2.

13. The fertilizer of claim 1, wherein the fertilizer composition is dried.

14. A method of producing a fertilizer composition, the method comprising:
combining a mixed plastic waste slag comprising coke with a metal slag comprising slag from the production of a metal to generate a mixture; and
contacting the metal slag and/or coke with nitric acid.

15. The method of claim 14, wherein the fertilizer composition comprises high molecular weight organic compounds and one or more of: CaO; CdO; BaO; ZnO; and PbO.

16. The method of claim 14, wherein the fertilizer composition comprises high molecular weight organic compounds, CaO, CdO, BaO, ZnO, and PbO.

17. The method of claim 16, wherein the contacting step occurs at 20 to 80° C. for 30 minutes to 6 hours.

18. The method of claim 14, wherein the contacting step generates calcium nitrate and/or magnesium nitrate.

19. The method of claim 14, further comprising drying the mixture.

20. A method of fertilizing, the method comprising contacting a plant, a soil, water, or a combination thereof with the fertilizer composition of claim 1.
